(19) United States
(12) Patent Application Publication
(10) Pub. No.: US 2020/0379485 A1
(43) Pub. Date: Dec. 3, 2020

(54) METHOD FOR POSITIONING A MOVABLE PLATFORM, AND RELATED DEVICE AND SYSTEM

(71) Applicant: SZ DJI TECHNOLOGY CO., LTD., Shenzhen (CN)

(72) Inventors: Ketan TANG, Shenzhen (CN); Jiarong LIN, Shenzhen (CN)

(21) Appl. No.: 16/996,664

(22) Filed: Aug. 18, 2020

Related U.S. Application Data
(63) Continuation of application No. PCT/CN2018/077660, filed on Feb. 28, 2018.

(51) Int. Cl. G05D 1/08; G05D 1/00; B64C 39/02; G06T 7/80; G06T 7/73

(52) U.S. Cl. CPC G05D 1/0808; G05D 1/0094; B64C 39/024; G06T 2207/30244; G06T 7/74; B64C 2201/027; B64C 2201/127; G06T 7/80

(57) ABSTRACT

A method for positioning a movable platform, and related device and system are provided. The method includes obtaining an image obtained by photographing a positioning auxiliary device. The positioning auxiliary device is configured with a plurality of calibration objects of at least two different size types. The method also includes detecting image objects of each calibration object of each size type in the image, and selecting image objects of calibration objects of one or more size types from the detected image objects. Further, the method includes according to the selected image objects, determining attitude information and/or position information of the movable platform with respect to the positioning auxiliary device.

### CROSS-REFERENCE TO RELATED APPLICATION

This application is a continuation of International Application No. PCT/CN2018/077660, filed on Feb. 28, 2018, the entirety of which is incorporated herein by reference.

### TECHNICAL FIELD

The present disclosure generally relates to the field of positioning technology and, more particularly, relates to a method for positioning a movable platform, and related device and system.

### BACKGROUND

During the cruising process of a movable platform (e.g., an unmanned aerial vehicle, an unmanned vehicle, etc.), it is often desirable to make a determination of status information, such as position and attitude information. At present, in some application scenarios, the movable platform can determine the above information in combination with a positioning auxiliary device configured with a calibration object, and by detecting the calibration object of the positioning auxiliary device.

However, a distance between the movable platform and the positioning auxiliary device is often uncertain. When the movable platform is too far away from the positioning auxiliary device, the calibration object observed by the movable platform may become too small to be detected, and the movable platform cannot determine the above-mentioned status information based on the calibration object. When the movable platform is too close to the positioning auxiliary device, because a quantity of detected calibration objects is too small, the movable platform still cannot determine the above-mentioned status information based on the calibration object. The disclosed method for positioning a movable platform, and related device and system are directed to solve one or more problems set forth above and other problems.

### SUMMARY

One aspect of the present disclosure provides a method for positioning a movable platform. The method includes obtaining an image obtained by photographing a positioning auxiliary device. The positioning auxiliary device is configured with a plurality of calibration objects of at least two different size types. The method also includes detecting image objects of each calibration object of each size type in the image, and selecting image objects of calibration objects of one or more size types from the detected image objects. Further, the method includes according to the selected image objects, determining attitude information and/or position information of the movable platform with respect to the positioning auxiliary device.

Another aspect of the present disclosure provides a device for positioning a movable platform. The device includes a memory configured to store program instructions and a processor coupled to the memory. When the program instructions being executed, the processor is configured to obtain an image obtained by photographing a positioning auxiliary device. The positioning auxiliary device is configured with a plurality of calibration objects of at least two different size types. The processor is also configured to detect image objects of each calibration object of each size type in the image, and select image objects of the calibration objects of one or more size types from the detected image objects. Further, the processor is configured to according to the selected image objects, determine attitude information and/or position information of the movable platform with respect to the positioning auxiliary device.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic structural diagram of an exemplary positioning auxiliary device consistent with disclosed embodiments of the present disclosure;

FIG. 2A illustrates a schematic structural diagram of an exemplary separated substrate included in a positioning auxiliary device in an application scenario consistent with disclosed embodiments of the present disclosure;

FIG. 2B illustrates a schematic structural diagram of an exemplary stacked substrate included in a positioning auxiliary device in an application scenario consistent with disclosed embodiments of the present disclosure;

FIG. 3A illustrates a local top view of an exemplary positioning auxiliary device in an application scenario consistent with disclosed embodiments of the present disclosure;

FIG. 3B illustrates a local top view of another exemplary positioning auxiliary device in an application scenario consistent with disclosed embodiments of the present disclosure;

FIG. 4 illustrates a schematic flowchart of an exemplary method for positioning a movable platform consistent with disclosed embodiments of the present disclosure;

FIG. 5 illustrates a schematic structural diagram of an exemplary system for positioning a movable platform consistent with disclosed embodiments of the present disclosure;

FIG. 6 illustrates a schematic flowchart of S42 in another exemplary method for positioning a movable platform consistent with disclosed embodiments of the present disclosure;

FIG. 7 illustrates a schematic flowchart of another exemplary method for positioning a movable platform consistent with disclosed embodiments of the present disclosure;

FIG. 8 illustrates a schematic structural diagram of an exemplary device for positioning a movable platform consistent with disclosed embodiments of the present disclosure;

FIG. 9 illustrates a schematic structural diagram of an exemplary movable platform consistent with disclosed embodiments of the present disclosure; and

FIG. 10 illustrates a schematic structural diagram of an exemplary storage device consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

When a component is called to be “fixed to” another component, the component may be directly on another component, or there may be a component between thereof. When a component is considered to be “connected” to another component, the component may be directly connected to another component, or there may be a component between thereof. The term “and/or” may include one or more of any and entire combinations of the associated listed items. In the case of no conflict, the following embodiments and characteristics can be combined with each other.

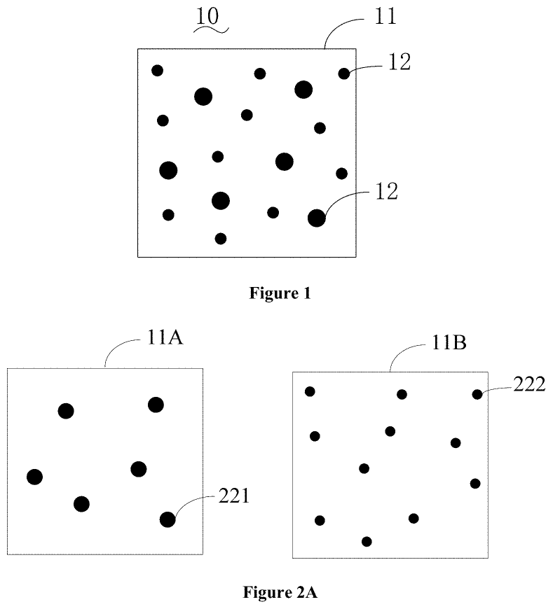

The present disclosure provides a method for positioning a movable platform. To facilitate understanding of the method, a positioning auxiliary device may be first described. FIG. 1 illustrates a schematic structural diagram of a positioning auxiliary device consistent with disclosed embodiments of the present disclosure. Referring to FIG. 1, the positioning auxiliary device 10 may be configured for positioning a movable platform. The movable platform may be any device capable of moving under an external force or under self-configured power system, e.g., an unmanned aerial vehicle, or an unmanned vehicle, etc. In one embodiment, the positioning auxiliary device 10 may include a carrier device 11 and calibration objects 12 having at least two size types disposed on the carrier device 11. For illustrative purposes, the calibration objects having at least two size types may include calibration objects having two size types. In other words, the calibration objects having at least two size types may include calibration objects having a first size type and calibration objects having a second size type.

In one embodiment, the carrier device 11 may include one or more substrates. The substrate may be a metal plate, or a non-metal plate, e.g., cardboard or a plastic plate, etc. The calibration object 12 may be disposed on the substrate by etching, coating, printing, displaying, etc. The carrier device 11 may include a plurality of substrates placed on top of each other, and one or more size types of calibration objects 12 may be disposed on each substrate.

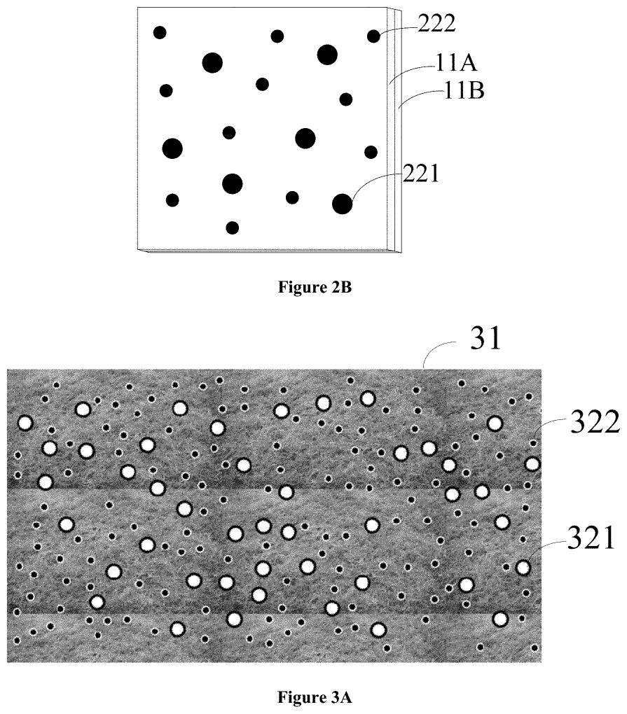

Referring to FIG. 2A, calibration objects having a first size type 221 may be disposed on a substrate 11A, and calibration objects having a second size type 222 may be disposed on a substrate 11B. A position of the calibration object on each substrate may be different. Any other substrate except a bottom substrate may be configured to be transparent. Therefore, after forming the carrier device 11 by stacking the plurality of substrates, the calibration objects 221/222 disposed on each substrate may be observed from the front of the carrier device 11, as illustrated in FIG. 2B.

In certain embodiments, the carrier device 11 may include any device configured for displaying, e.g., a display screen or a projection screen. The calibration object 12 may be displayed on the carrier device 11. In one embodiment, the calibration object 12 may be displayed on the carrier device 11 through a control device or a projector. Therefore, the carrier device 11 and the method for disposing the calibration object 12 on the carrier device 11 may not be limited by the present disclosure.

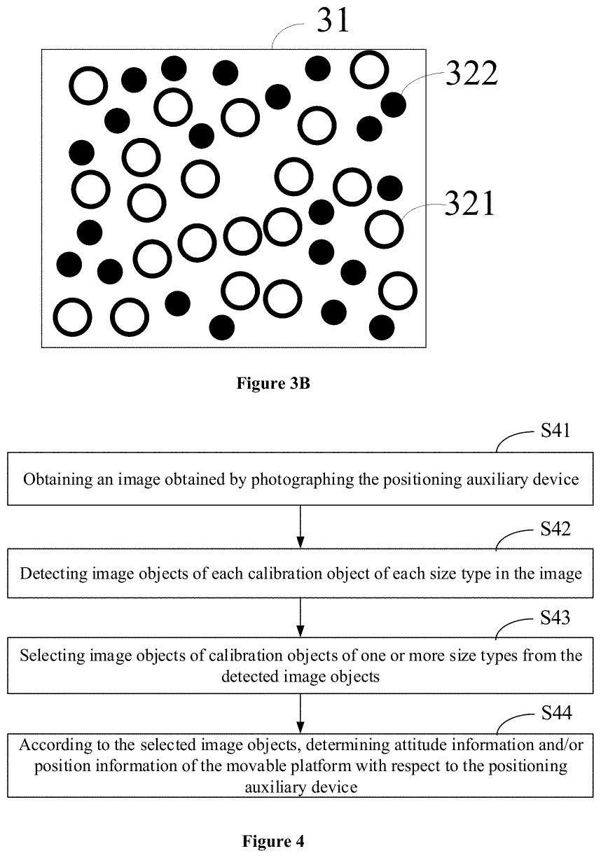

In addition, the positioning auxiliary device may further include an image provided on the carrier device 11, and the image may refer to as a background image of the calibration object 12. Referring to FIG. 3A, the image may be a texture image. In another embodiment, referring to FIG. 3B, the image may be a solid color map, which may have a color different from the calibration object 12. Correspondingly, when the carrier device 11 includes a plurality of substrates stacked on top of each other, the image may be provided on a bottommost substrate to form a background image of the calibration objects 12 disposed on entire substrates.

In one embodiment, the calibration object 12 may include randomly distributed dot-shaped region, and may refer to as random points. The calibration object 12 may have any shape, e.g., a circle, a square, or an oval, etc. The calibration object 12 may have at least two size types, and a quantity of each calibration object of each size types 12 may be more than one. Compared with an existing positioning auxiliary device with a single-sized calibration object, the positioning auxiliary device in the disclosed embodiments may include different size types of calibration objects 12. Therefore, even when the distance between the movable platform and the positioning auxiliary device is substantially large, the large-sized calibration object may still be detected. When the distance between the movable platform and the positioning auxiliary device is substantially small, a certain quantity of small-sized calibration objects may still be detected. Thus, according to different scenarios, different size types of calibration objects may be selected to determine the attitude information and/or position information of the movable platform to ensure the reliability and robustness of positioning.

To further prevent the distance between the movable platform and the calibration object from affecting the determination of the attitude information and/or position information, calibration objects having different size types 12 on the carrier device 11 may have a different density. In one embodiment, the small-sized calibration objects 12 may have a density greater than the large-sized calibration objects 12. Therefore, when the distance between the movable platform and the positioning auxiliary device is substantially small, because the small-sized calibration objects have a substantially large density, a sufficient quantity of small-sized calibration objects may be detected, thereby achieving determination of attitude information and/or position information of the movable platform.

Further, to improve the accurate detection of the calibration object when determining the attitude information and/or position information of the movable platform, calibration objects having at least one size type 12 on the carrier device 11 may be provided with an outer ring. The outer ring may have a color different from the internal portion of the outer ring. In one embodiment, the outer ring may have a black color, and the internal portion of the outer ring may have a white color. In another embodiment, the outer ring may have a white color, and the internal portion of the outer ring may have a black color. Because the outer ring has a color different from the internal portion of the outer ring, the contrast may be substantially high. Through the color difference between the outer ring and the internal portion of the outer ring, the calibration object may be detected from the image. Therefore, no matter what kind of content is provided in the background image of the calibration object, the detection of the calibration object may not be affected, thereby reducing the requirements for the background image of the calibration object, and improving the accuracy and reliability of the detection. In one embodiment, the background image of the calibration object may have a substantially large interference, and the grayscale difference between colors of the outer ring and the internal portion of the outer ring may be set to be larger than a preset threshold, to improve the contrast between the outer ring and the internal portion thereof.

In addition, on the carrier device 11, a central portion of calibration object of one size type 12 may have a color different from a central portion of calibration object of another size type. In view of this, calibration objects having different size types may be distinguished through the color of the central portion of the calibration object. In one embodiment, referring to FIG. 3A, calibration objects having two size types 321 and 322 may be disposed on the carrier device 31. The calibration objects 321 and 322 each may have a circular outer ring. The central portion of the calibration object 321, i.e., the internal portion of the outer ring, may be white, and the outer ring may be black. The central portion of the calibration object 322, i.e., the internal portion of the outer ring, may be black, and the outer ring may be white.

In another embodiment, referring to FIG. 3B, calibration objects having two size types 321 and 322 may be disposed on the carrier device 31. The calibration object 321 may have a circular outer ring, and the calibration object 322 may not have an outer ring. The central portion of the calibration object 321, i.e., the internal portion of the outer ring, may be white, and the outer ring may be black. The calibration object 322 may be black.

FIG. 4 illustrates a schematic flowchart of a method for positioning a movable platform consistent with disclosed embodiments of the present disclosure. Referring to FIG. 4, in one embodiment, the method may be executed by a positioning device. Further, the method may be executed by a processor of the positioning device. The positioning device may be a processing device disposed on the movable platform. The method may include the following.

S41: obtaining an image obtained by photographing the positioning auxiliary device.

In one embodiment, the positioning auxiliary device may be disposed on the ground. For example, the positioning auxiliary device may be tiled on the ground, or may be disposed perpendicular to the ground. When moving or flying on the ground where the positioning auxiliary device is disposed, the movable platform may observe the positioning auxiliary device by a photographing device disposed thereon.

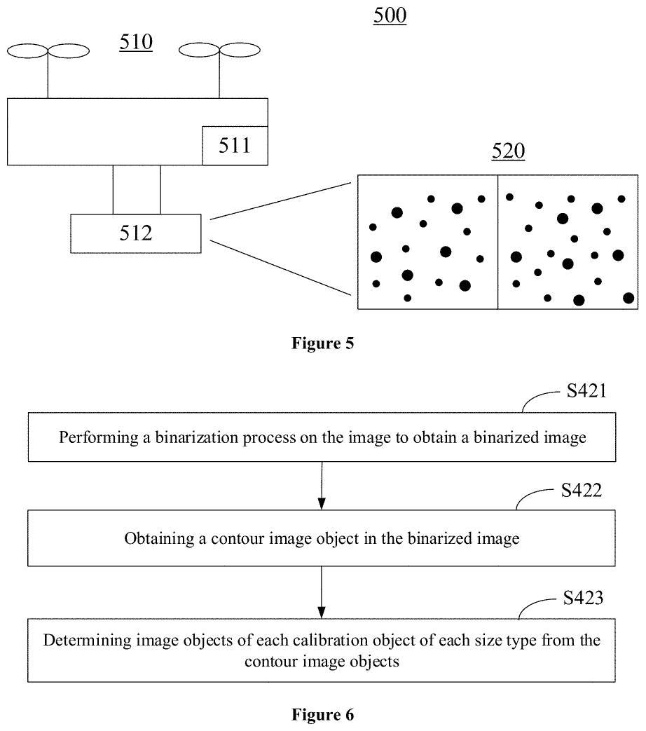

Referring to FIG. 5, when moving, the movable platform 510 may obtain an image by using the photographing device 512 disposed on the movable platform to photograph the positioning auxiliary device 520 disposed on the ground in advance. The positioning device 511 disposed on the movable platform 510 may obtain an image captured by the photographing device 512. A quantity of the positioning auxiliary devices may be one or more. When the quantity of the positioning auxiliary devices is more than one, relative positions between the plurality of positioning auxiliary devices may be fixed. The relative positions between the plurality of positioning auxiliary devices may not desire to be obtained in advance, and may be obtained by performing the disclosed methods in combination with an existing calibration method.

The positioning auxiliary device may be configured with a plurality of calibration objects of at least two different size types. Further, the positioning auxiliary device may be any one positioning auxiliary device in the above-disclosed embodiments.

S42: detecting image objects of each calibration object of each size type in the image.

In one embodiment, after obtaining the image obtained by photographing the positioning auxiliary device, the positioning device may detect the image objects of the calibration objects from the image, and may further determine a correspondence relationship between each image object and the size type, to determine that each image object corresponds to which size type of calibration object. The image object may be an image area of the captured calibration object in the image.

Because the calibration object disposed on the positioning auxiliary device is an object with obvious characteristic, and the characteristic, e.g., size, etc., of calibration object having different size type is different, according to the characteristic of the calibration object, the positioning device may detect the image objects of calibration objects of different size types from the image. In one embodiment, using a blob detector algorithm or any other detection algorithm, an image area representing a calibration object may be detected from the image as the image object of the calibration object. According to the size of the image object or any other distinguished characteristic, the size type corresponding to the detected image object may be determined.

S43: selecting image objects of the calibration objects of one or more size types from the detected image objects.

After detecting the above-described image objects from the image, the positioning device may select the image objects of the calibration objects of one or more size types from the detected image objects according to a preset strategy. According to different practical applications, the preset strategy may include dynamically selecting different image objects of the calibration objects of one or more size types.

S44: according to the selected image objects, determining attitude information and/or position information of the movable platform with respect to the positioning auxiliary device.

In one embodiment, after selecting the image objects, the positioning device may first extract the characteristic parameters of each selected image object from the image, and may match the pre-stored characteristic parameters of the calibration objects of the positioning auxiliary device, to determine a calibration object corresponding to each selected image object. According to the determined calibration object, the attitude information and/or position information of the movable platform with respect to the positioning auxiliary device may be determined by using a perspective n points (PnP) algorithm and any other related attitude solving algorithm.

In practical applications, above information may not be determined according to the image objects selected in S43. In view of this, S43 may be re-executed to reselect the image objects of the calibration objects of one or more size types, and the reselected image objects may at least partially have size types different from the previously selected image objects. Using the reselected image objects, the positioning device may determine the attitude information and/or position information of the positioning auxiliary device with respect to the movable platform again, and so on, until the attitude information and/or position information of the movable platform with respect to the positioning auxiliary device can be determined.

FIG. 6 illustrates a schematic flowchart of S42 in a method for positioning the movable platform consistent with disclosed embodiments of the present disclosure. Referring to FIG. 6, in one embodiment, the positioning device performing S42 illustrated in FIG. 4 may include the following.

S421: performing a binarization process on the image to obtain a binarized image.

In one embodiment, to eliminate the interference of the interference source in the image (e.g., a textured image in the positioning auxiliary device) on the detection of the calibration object, the image may be binarized, and then an image object of the calibration object may be obtained by detecting the processed image. A fixed threshold may be used to binarize the image, or a dynamic threshold may be used to binarize the image.

S422: obtaining contour image objects in the binarized image.

In one embodiment, after performing S421, the binarized image may include a plurality of contour image objects. The contour image objects may include a contour object image corresponding to the calibration object, i.e., the image object of the calibration object, in the positioning auxiliary device. In certain embodiments, the contour image object may include a contour object image corresponding to the interference source, i.e., an image object of the interference source.

S423: determining the image objects of each calibration object of each size type from the contour image objects.

The positioning device may desire to determine which contour object is image object of the calibration object from the obtained contour image objects. Because the calibration object in the positioning auxiliary device has obvious characteristic, the image object of the calibration object may theoretically meet the characteristic requirements of a corresponding calibration object. Therefore, the positioning device may determine whether the characteristic parameter corresponding to each contour image object meets the preset requirements, and may determine the image objects of each calibration object of each size type from the contour image objects whose characteristic parameters meet the preset requirements.

In certain embodiments, the calibration object may have a clear shape characteristic, and, thus, according to the shape characteristic parameter of the contour image object, whether the contour image object is an image object of the calibration object may be determined. For example, the positioning device may determine a shape characteristic parameter of each contour image object, may determine whether the shape characteristic parameter corresponding to each contour image object meets the preset requirements, and may determine the image objects of each calibration object of each size type from the contour image objects whose shape characteristic parameters meet the preset requirements. The shape characteristic parameter may include one or more shape characteristics, e.g., roundness, area, and convexity, etc. The roundness may refer to a ratio of an area of a contour image object over an area of an approximate circle thereof. The convexity may refer to a ratio of the area of the contour image object over an area of an approximate polygonal hull thereof.

The preset requirements may include whether the shape characteristic parameter of the contour image object is within a preset threshold. If the shape characteristic parameter of the contour image object is within the preset threshold, the contour image object may be determined as an image object of the calibration object. In one embodiment, the preset requirements may include that at least two of the roundness, area, and convexity of the contour image object are within the preset threshold. The positioning device may determine the contour image object whose at least two of the roundness, area, and convexity are within the preset threshold as the image object of the calibration object, and then may determine the image objects of each calibration object of each size type from the determined image objects of the calibration objects.

In one embodiment, according to the size characteristic of the image object of the calibration object, the positioning device may determine the size type corresponding to the image object of each calibration object. For example, after determining the contour image object that meets the preset requirements as the image object of the calibration object, the positioning device may compare the size characteristics of each determined image object with the pre-stored size characteristics of each calibration object of each size type, and may further determine each image object as an image object of a calibration object having the same or similar size characteristic. The size characteristic may include area, perimeter, radius, side length, etc., of the image object or the calibration object.

In the positioning auxiliary device, when a central portion of a calibration object of a size type has a color different from a central portion of a calibration object of another size type, according to pixel value of the internal portion of the image object of the calibration object, the positioning device may determine the size type corresponding to the image object of each calibration object. In one embodiment, after determining the contour image objects that meet the preset requirements as the image objects of the calibration objects, the positioning device may determine a pixel value of internal portion of the contour image object that meets the preset requirements. According to the pixel value and a pixel value characteristic of the internal portion of each calibration object of each size type, the positioning device may determine the image objects of each calibration object of each size type.

The positioning device may pre-store the pixel value characteristic of the internal portion of each calibration object of each size type. For example, the positioning device may pre-store a pixel value characteristic of 255 of the internal portion of the calibration objects having the first size type, and a pixel value characteristic of 0 of the internal portion of the calibration objects having the second size type. For a contour image object that meets the preset requirements, the positioning device may further detect whether the pixel value of the internal portion of the contour image object is 0 or 255. If the pixel value is 0, the contour image object may be an image object of the calibration objects having the second size type. If the pixel value is 255, the contour image objects may be image objects of the calibration objects having the first size type.

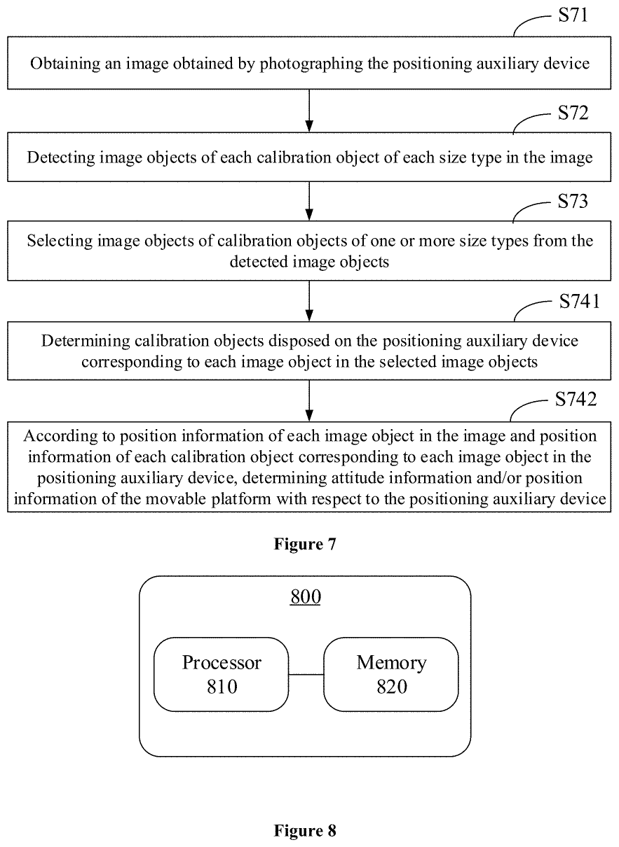

FIG. 7 illustrates a schematic flowchart of another method for positioning a movable platform consistent with disclosed embodiments of the present disclosure. In one embodiment, referring to FIG. 7, the method may be executed by the positioning device, and may include the following.

S71: obtaining an image obtained by photographing the positioning auxiliary device.

S72: detecting image objects of each calibration object of each size type in the image. Detailed descriptions of S71 and S72 may refer to the related descriptions of S41 and S42, respectively, which are not repeated herein.

S73: selecting image objects of the calibration objects of one or more size types from the detected image objects.

In one embodiment, image objects of the calibration objects of one or more size types may be selected from the detected image objects according to a preset strategy. In practical applications, selecting the image objects may include the following.

In one embodiment, according to the size types of historically matched calibration objects, image objects of the calibration objects of one or more size types may be selected from the detected image objects.

The size type of the historically matched calibration object may be a size type of a calibration object selected from a historical image obtained by photographing the positioning auxiliary device and capable of determining attitude information and/or position information of the movable platform with respect to the positioning auxiliary device. The historical image in the disclosed embodiments may be a previous one or several frame image before the current frame image. Determining the attitude information and/or position information of the movable platform with respect to the positioning auxiliary device may refer to successfully determining the attitude information and/or position information of the movable platform with respect to the positioning auxiliary device. In one embodiment, after performing the processes in the disclosed methods on the previous frame image obtained by photographing the positioning auxiliary device, the positioning device may ultimately determine the attitude information and/or position information of the movable platform with respect to the positioning auxiliary device according to the image objects of the calibration objects having the first size type in the previous frame image. In other words, the size type of the historically matched calibration object may be the first size type. For the image object detected from the current frame image, the image objects of the calibration objects having the first size type may be selected to determine the attitude information and/or position information of the movable platform with respect to the positioning auxiliary device.

In another embodiment, according to a quantity of image objects of each calibration object of each size type, image objects of the calibration objects of one or more size types may be selected from the detected image objects. For illustrative purposes, the positioning auxiliary device may include the calibration objects having the first size type and the calibration objects having the second size type. The first size type may have a size larger than the second size type.

The positioning device may determine a ratio of the quantity of image objects of calibration objects of the first size type over the total quantity of detected image objects. When the determined ratio is greater than or equal to a first preset ratio, the image objects of the calibration objects having the first size type may be selected. When the determined ratio is smaller than the first preset ratio and greater than or equal to a second preset ratio, the image objects of the first and the second size types of calibration objects may be selected. When the determined ratio is smaller than the second preset ratio, the image objects of the calibration objects having the second size types may be selected. In another embodiment, the positioning device may obtain the quantity of image objects of the calibration objects having the first size type and the quantity of image objects of the calibration objects having the second size types, respectively, and may select the image objects of calibration objects with a size type having a larger quantity.

In another embodiment, according to historical distance information, image objects of the calibration objects of one or more size types may be selected from the detected image objects. The historical distance information may refer to distance information of the movable platform with respect to the positioning auxiliary device determined according to the historical image obtained by photographing the positioning auxiliary device. For illustrative purposes, the positioning auxiliary device may include the calibration objects having the first size type and the calibration objects having the second size type. The first size type may have a size larger than the second size type.

The positioning device may determine distance information of the movable platform with respect to the positioning auxiliary device determined according to the previous frame image obtained by photographing the positioning auxiliary device. When the determined distance information is greater than or equal to a first preset distance, image objects of the calibration objects having the first size type may be selected. When the determined distance information is less than a first preset distance and greater than or equal to a second preset distance, image objects of the first and second size types of calibration objects may be selected. When the determined distance information is less than the second preset distance, image objects of the calibration objects having the second size type may be selected.

It can be understood that the positioning device may comprehensively select image objects of the calibration objects of one or more size types from the detected image objects based on the above two or more factors, which is not limited by the present disclosure.

Further, in certain embodiments, the attitude information and/or position information of the movable platform with respect to the positioning auxiliary device may not be determined according to the selected image objects. Thus, the positioning device may reselect image objects of one or more size types of the calibration objects, and according to the reselected image objects, to determine the attitude information and/or position information of the movable platform with respect to the positioning auxiliary device, and so on, until the attitude information and/or position information of the movable platform with respect to the positioning auxiliary device can be determined according to the selected image objects. The reselected image objects may at least partially have size types different from the previously selected image objects. In addition, the positioning device may obtain a next frame image obtained by photographing the positioning auxiliary device by the photographing device, and then may select image objects of the calibration objects of one or more size types from the image according to the above-described manner.

In another embodiment, a selection order of the detected image objects may be determined, and then according to the selection order, image objects of the calibration objects of one or more size types may be selected from the detected image objects. In one embodiment, to reduce the quantity of selections, the selection order may be determined according to one or more of the size types of the historically matched calibration objects, the quantity of image objects of each calibration object of each size type, and the historical distance information. For illustrative purposes, the positioning auxiliary device may include the calibration objects having the first size type and the calibration objects having the second size type.

In one embodiment, if the positioning device ultimately selects the image objects of the calibration objects having the first size type in the previous frame image, i.e., the size type of the historically matched calibration object is the first size type, the selection order may be image objects of the calibration objects having the first size type, image objects of the first and second size types of calibration objects, and image objects of the calibration objects having the second size type. The positioning device may select the image objects of the calibration objects having the first size type to determine attitude information and/or position information of the movable platform with respect to the positioning auxiliary device.

If the attitude information and/or position information of the movable platform with respect to the positioning auxiliary device are successfully determined according to the image objects of the calibration objects having the first size type, the movement of the movable platform may be controlled according to the attitude information and/or position information. If the attitude information and/or position information cannot be determined, the image objects of the first and second size types of calibration object may be selected to determine the attitude information and/or position information of the movable platform with respect to the positioning auxiliary device, and so on, until the attitude information and/or position information of the movable platform with respect to the positioning auxiliary device are successfully obtained.

If the positioning device ultimately selects the image objects of the calibration objects having the second size type in the previous frame image, the selection order may be image objects of the calibration objects having the second size type, image objects of the first and second size types of calibration objects, and image objects of the calibration objects having the first size type.

If the positioning device ultimately selects the image objects of the first and second size types of calibration objects in the previous frame image, and a detected ratio of the image objects corresponding to the first size type is greater than a pre-stored ratio of the calibration objects having the first size type in the positioning auxiliary device, the selection order may be image objects of the first and second size types of calibration object, image objects of the calibration objects having the first size type, and image objects of the calibration objects having the second size type.

If the positioning device ultimately selects the image objects of the first and second size types of calibration objects in the previous frame image, and a detected ratio of the image objects corresponding to the second size type is greater than a pre-stored ratio of the calibration objects having the second size type in the positioning auxiliary device, the selection order may be image objects of the first and second size types of calibration objects, image objects of the calibration objects having the second size type, and image objects of the calibration objects having the first size type.

In another embodiment, if the quantity of image objects of the calibration objects having the first size type is greater than the quantity of image objects of the calibration objects having the second size type, a selection order determined by the positioning device may be image objects of the calibration objects having the first size type, image objects of the first and second size types of calibration objects, and image objects of the calibration objects having the second size type. After determining the selection order, the positioning device may select the image objects according to the selection order to determine the attitude information and/or position information of the movable platform with respect to the positioning auxiliary device.

In another embodiment, the first size type may have a size larger than the second size type. The positioning device may obtain distance information of the movable platform with respect to the positioning auxiliary device determined according to the previous frame image obtained by photographing the positioning auxiliary device. If the distance information is greater than or equal to a first preset distance, the selection order determined by the positioning device may be image objects of the calibration objects having the first size type, image objects of the first and second size types of calibration objects, and image objects of the calibration objects having the second size type. After determining the selection order, the positioning device may select the image objects according to the selection order to determine the attitude information and/or position information of the movable platform with respect to the positioning auxiliary device.

S741: determining calibration objects disposed on the positioning auxiliary device corresponding to each image object in the selected image objects.

In one embodiment, determining the attitude information and/or position information of the movable platform with respect to the positioning auxiliary device according to the selected image objects may include S741 and S742.

In one embodiment, the positioning device may match the selected image objects with calibration objects disposed on the positioning auxiliary device. In other words, the positioning device may determine a correspondence relationship between each selected image object and the calibration object disposed on the positioning auxiliary device.

Further, the positioning device may determine position characteristic parameter of each selected image object, and obtain position characteristic parameter of the calibration object disposed on the positioning auxiliary device. According to the position characteristic parameter of each selected image object and the position characteristic parameter of the calibration object disposed on the positioning auxiliary device, the positioning device may determine the calibration object disposed on the positioning auxiliary device corresponding to each image object in the selected image objects.

The positioning device may pre-store the position characteristic parameter of the calibration object disposed on the positioning auxiliary device. The position characteristic parameter may represent a position relationship of an image object or a calibration object with respect to one or more other image objects and calibration objects, respectively. In one embodiment, the position characteristic parameter may be a characteristic vector. According to the determined position characteristic parameter of the image object and the pre-stored positon characteristic parameter of the calibration object disposed on the positioning auxiliary device, the positioning device may match the selected image object with the calibration object disposed on the positioning auxiliary device, and may obtain the calibration object matched with the selected image object. In another embodiment, when the position characteristic parameter of the image object is the same as or similar to the pre-stored position characteristic parameter of the calibration object disposed on the positioning auxiliary device, it may be determined that the image object matches the calibration object.

In certain embodiments, the position characteristic parameter of the calibration object disposed on the positioning auxiliary device may be pre-stored in a storage device of the movable platform.

In certain embodiments, the position characteristic parameter of the calibration object disposed on the positioning auxiliary device may be stored by storing a corresponding hash value through a hash operation. Correspondingly, when obtaining the position characteristic parameter of the selected image object, the positioning device may perform the same hash operation on the position characteristic parameter of the selected image object to obtain a hash value. When the calculated hash value is the same as the pre-stored hash value, it may be determined that the corresponding image object matches the corresponding calibration object.

S742: according to position information of each image object in the image and position information of the calibration objects corresponding to each image object in the positioning auxiliary device, determining attitude information and/or position information of the movable platform with respect to the positioning auxiliary device.

In one embodiment, according to the position information of image object in the image and the position information of the calibration object corresponding to the image object disposed on the positioning auxiliary device, the positioning device may use the PnP algorithm to determine attitude information and/or position information of the movable platform with respect to the positioning auxiliary device.

In certain embodiments, when the quantity of used positioning auxiliary devices is more than one, the positioning device may match the position characteristic parameter of the selected image object and the pre-stored position characteristic parameter of the calibration object disposed on each positioning auxiliary device, to determine the positioning auxiliary device where the calibration object corresponding to the selected image object is located. Further, the positioning device may determine the calibration object corresponding to the selected image object on the determined positioning auxiliary device. In addition, the positioning device may first obtain the position information of the determined positioning auxiliary device.

In one embodiment, a positioning auxiliary device pre-stored with position information thereof may be used as a reference positioning auxiliary device. According to the pre-stored position information of the reference positioning auxiliary device and relative position of the determined positioning auxiliary device with respect to the reference positioning auxiliary device, the position information of the determined positioning auxiliary device may be obtained. After obtaining the position information of the determined positioning auxiliary device, according to the position information of the determined positioning auxiliary device, the position information of the image object in the image, and the position information of the calibration object corresponding to the image object on the positioning auxiliary device, the positioning device may determine attitude information and/or position information of the movable platform with respect to the positioning auxiliary device.

FIG. 8 illustrates a schematic structural diagram of a device for positioning a movable platform consistent with disclosed embodiments of the present disclosure. Referring to FIG. 8, a positioning device 800 may be configured to determine attitude information and/or position information of the movable platform. In one embodiment, the positioning device 800 may include a processor 810 and a memory 820 that are connected to each other.

The memory 820 may include a read-only memory and a random access memory, and may provide instructions and data to the processor 810. The memory 820 may further partially include a non-volatile random access memory.

The processor 810 may be a central processing unit (CPU). The processor may be any other general-purpose processor, a digital signal processor (DSP), an application specific integrated circuit (ASIC), a field-programmable gate array (FPGA), or any other programmable logic device, discrete gate or transistor logic device, separate hardware component, etc. The general-purpose processor may be a microprocessor, or any conventional processor, etc.

The memory 820 may be configured to store program instructions. The processor 810 may invoke the program instructions, and when executing the program instructions, may be configured to: obtain an image obtained by photographing a positioning auxiliary device, where the positioning auxiliary device may be configured with a plurality of calibration objects of at least two different size types; detect image objects of each calibration object of each size type in the image; select image objects of the calibration objects of one or more size types from the detected image objects; and determine attitude information and/or position information of the movable platform with respect to the positioning auxiliary device according to the selected image objects.

In certain embodiments, when detecting the image objects of each calibration object of each size type in the image, the processor 810 may be configured to: perform a binarization process on the image to obtain a binarized image; obtain contour image objects in the binarized image; and determine image objects of each calibration object of each size type from the contour image objects.

Further, when determining the image objects of each calibration object of each size type from the contour image objects, the processor 810 may be configured to: determine shape characteristic parameters of each contour image object; determine whether the shape characteristic parameters corresponding to each contour image object meet preset requirements; and determine the counter image objects whose shape characteristic parameters meet the preset requirements as the image objects of calibration objects having a corresponding size type.

Further, when determining the counter image objects whose shape characteristic parameters meet the preset requirements as the image objects of calibration objects having the corresponding size type, the processor 810 may be configured to: determine a pixel value of the internal portion of the contour image object that meets preset requirements; and according to the pixel value and pixel value characteristic of internal portion of the calibration object of each size type, determine the counter image objects that meet the preset requirements as the image objects of calibration objects having a size type whose pixel value characteristic matches the pixel value.

In certain embodiments, when determining attitude information and/or position information of the movable platform with respect to the positioning auxiliary device according to the selected image objects, the processor 810 may be configured to: determine calibration objects disposed on a positioning auxiliary device corresponding to each image object in the selected image objects; and according to the position information of each image object in the image and the position information of the calibration objects corresponding to each image object on the positioning auxiliary device, determine attitude information and/or position information of the movable platform with respect to the positioning auxiliary device.

Further, when determining the calibration objects disposed on the positioning auxiliary device corresponding to each image object in the selected image objects, the processor 810 may be configured to: determine position characteristic parameters of each selected image object; and according to the position characteristic parameters of each selected image object and the position characteristic parameters of the calibration objects disposed on the positioning auxiliary device, determine the calibration objects disposed on the positioning auxiliary device corresponding to each image object in the selected image objects.

The position characteristic parameter of the calibration object disposed on the positioning auxiliary device may be pre-stored in the memory 820, or may be pre-stored in any other storage device of the movable platform.

In certain embodiments, when selecting image objects of the calibration objects of one or more size types from the detected image objects, the processor 810 may be configured to according to the size types of historically matched calibration objects, select image objects of the calibration objects of one or more size types from the detected image objects. The size type of the historically matched calibration object may be a size type of a calibration object selected from a historical image obtained by photographing the positioning auxiliary device and capable of determining attitude information and/or position information of the movable platform with respect to the positioning auxiliary device.

In certain embodiments, when selecting image objects of the calibration objects of one or more size types from the detected image objects, the processor 810 may be configured to according to a quantity of image objects of each calibration object of each size type, select image objects of the calibration objects of one or more size types from the detected image objects.

In certain embodiments, when selecting image objects of the calibration objects of one or more size types from the detected image objects, the processor 810 may be configured to according to historical distance information, select image objects of the calibration objects of one or more size types from the detected image objects. The historical distance information may refer to distance information of the movable platform with respect to the positioning auxiliary device determined according to a historical image obtained by photographing the positioning auxiliary device.

In certain embodiments, when selecting image objects of the calibration objects of one or more size types from the detected image objects, the processor 810 may be configured to: determine a selection order of the detected image objects; and according to the selection order, select image objects of the calibration objects of one or more size types from the detected image objects.

Further, when determining the selection order of the detected image objects, the processor 810 may be configured to: according to one or more of the size types of the historically matched calibration objects, the quantity of image objects of each calibration object of each size types, and the historical distance information, determine the selection order of the detected image objects. The size type of the historically matched calibration object may be a size type of a calibration object selected from a historical image obtained by photographing the positioning auxiliary device and capable of determining attitude information and/or position information of the movable platform with respect to the positioning auxiliary device. The historical distance information may refer to distance information of the movable platform with respect to the positioning auxiliary device determined according to the historical image obtained by photographing the positioning auxiliary device.

In certain embodiments, the movable platform may be an unmanned aerial vehicle. The device in the disclosed embodiments may be configured to perform the technical solutions of the methods in foregoing embodiments. The implementation principles and technical effects are similar, which are not repeated herein.

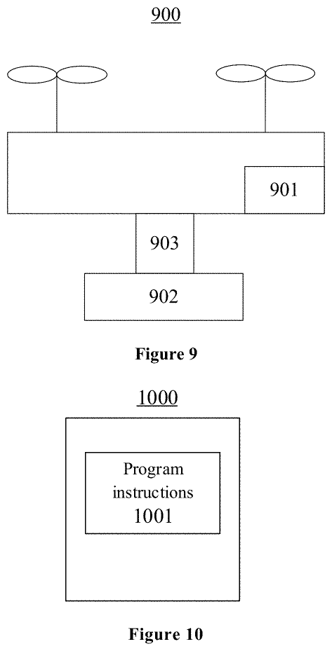

FIG. 9 illustrates a schematic structural diagram of a movable platform consistent with disclosed embodiments of the present disclosure. Referring to FIG. 9, the movable platform 900 may include a positioning device 901 and a photographing device 902 that are connected to each other. The photographing device 902 may be configured to obtain an image by photographing the positioning auxiliary device. The positioning device 901 may be the positioning device of the movable platform described in the foregoing disclosed embodiments, which are not repeated herein.

Further, the movable platform 900 may include a carrying device 903. The carrying device 903 may be configured to carry the photographing device 902. In certain embodiments, the movable platform 900 may be an unmanned aerial vehicle. The photographing device 902 may be a main camera of the unmanned aerial vehicle. The carrying device 903 may be a two-axis or three-axis gimbal. In one embodiment, in practical applications, the movable platform 900 may be provided with functional circuits, e.g., a vision sensor, and an inertial measurement device, etc.

FIG. 5 illustrates a schematic structural diagram of a system for positioning a movable platform consistent with disclosed embodiments of the present disclosure. Referring to FIG. 5, the positioning system 500 may include a movable platform 510 and at least one positioning auxiliary device 520. The movable platform 510 may include a positioning device 511 and a photographing device 512. A quantity of positioning auxiliary devices 520 may be determined according to practical applications. In one embodiment, for illustrative purposes, the positioning system 500 may include two positioning auxiliary devices 520. The positioning auxiliary device 520 and the movable platform 510 may be the positioning auxiliary device and the movable platform described in the above disclosed embodiments, respectively, which are not repeated herein.

In an application scenario, the movable platform may be an unmanned aerial vehicle, and the positioning auxiliary device may be tiled on the ground in advance. When sailing, the unmanned aerial vehicle may obtain an image by photographing the positioning device on the ground using the photographing device. The photographing device may output the image to the positioning device, such that the positioning device may perform the above-disclosed methods to determine the attitude information and/or position information of the unmanned aerial vehicle with respect to the positioning auxiliary device.

FIG. 10 illustrates a schematic structural diagram of a storage device consistent with disclosed embodiments of the present disclosure. In one embodiment, referring to FIG. 10, the storage device 1000 may store program instructions 1001. When the program instructions 1001 are executed on a processor, the technical solutions in the foregoing embodiments may be executed.

The storage device 1000 may be a medium capable of storing computer instructions, e.g., a U disk, a mobile hard disk, a read-only memory (ROM), a random access memory (RAM), a magnetic disk, or an optical disc, etc. Alternatively, the storage device 1000 may be a server storing the program instructions. The server may send the stored program instructions to any other device to be executed, or may execute the stored program instructions.

In the above-disclosed embodiments, the positioning auxiliary device may be configured with calibration objects having at least two size types. By detecting image obtained by photographing the positioning auxiliary device, the image objects of each calibration object of each size type may be obtained, and image objects of the calibration objects of one or more size types may be selected from the detected image objects. Further, according to the selected image objects of the calibration objects of one or more size types, the attitude information and/or position information of the movable platform with respect to the positioning auxiliary device may be determined. Because the calibration objects on the positioning auxiliary device have at least two size types, the movable platform may adaptively select calibration objects having different size type to determine the attitude information and/or position information of the movable platform with respect to the positioning auxiliary device. In view of this, even in different application scenarios, the attitude information and/or position information of the movable platform with respect to the positioning auxiliary device may be ensured to be determined by using the detected image objects of the calibration objects, thereby improving the reliability and robustness for determining the attitude information and/or position information of the movable platform.

In the disclosed embodiments, the disclosed methods and devices may be achieved in any other suitable manner. For example, the above-described device embodiments are merely schematic. For example, the division of the unit may be merely a logical function division, and may have any other suitable division manner in actual implementation. For example, a plurality of units or components may be combined or may be integrated into another system. Alternatively, some features may be ignored or may not be performed. In addition, the illustrated or discussed coupling or direct coupling or communication connection may be achieved through some interfaces, and indirect coupling or communication connection between devices or units may be electrical, mechanical or any other suitable form.

The units described as separate components may or may not be physically separated. The components displayed as units may or may not be physical units, i.e., may be located in a same place, or may be distributed on a plurality of network units. Some or entire units may be selected according to practical applications to achieve the purpose of scheme of the disclosed embodiments.

In addition, each functional unit in each embodiment of the present disclosure may be integrated into one processing unit. Alternatively, each unit may be separately physically provided. Alternatively, two or more units may be integrated into one unit. The above integrated unit may be achieved in the form of hardware, or may be achieved in the form of hardware and software functional unit.

When the integrated unit is implemented in the form of a software functional unit and sold or used as an independent product, the above integrated unit may be stored in a computer-readable storage medium. Part of or entire technical solutions of the present disclosure may be embodied in the form of a software product. The computer software product may be stored in a storage medium, and may include a plurality of instructions for enabling a computer device (e.g., a personal computer, a server, or a network device) or a processor to execute part of or entire the methods described in the disclosed embodiments of the present disclosure. The foregoing storage medium may include a U disk, a mobile hard disk, a read-only memory (ROM), a random access memory (RAM), a magnetic disk, a compact disc, or any other medium capable of storing program codes.

The above detailed descriptions only illustrate certain exemplary embodiments of the present disclosure, and are not intended to limit the scope of the present disclosure. Those skilled in the art can understand the specification as whole and technical characteristics in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A method for positioning a movable platform, comprising:
obtaining an image obtained by photographing a positioning auxiliary device, wherein the positioning auxiliary device is configured with a plurality of calibration objects of at least two different size types;
detecting image objects of each calibration object of each size type in the image;
selecting image objects of calibration objects of one or more size types from the detected image objects; and
according to the selected image objects, determining attitude information and/or position information of the movable platform with respect to the positioning auxiliary device.

2. The method according to claim 1, wherein detecting the image objects of each calibration object of each size type in the image includes:
performing a binarization process on the image to obtain a binarized image;
obtaining contour image objects in the binarized image; and
determining the image objects of each calibration object of each size type from the contour image objects.

3. The method according to claim 2, wherein determining the image objects of each calibration object of each size type from the contour image objects includes:
determining a shape characteristic parameter of each contour image object;
determining whether the shape characteristic parameter corresponding to each contour image object meets preset requirements; and
determining the image objects of each calibration object of each size type from the contour image objects whose shape characteristic parameters meet the preset requirements.

4. The method according to claim 3, wherein determining the image objects of each calibration object of each size type from the contour image objects whose shape characteristic parameters meet the preset requirements includes:
determining a pixel value of an internal portion of a contour image object that meets the preset requirements; and
according to the pixel value and a pixel value characteristic of an internal portion of each calibration object of each size type, determining the image objects of each calibration object of each size type.

5. The method according to claim 1, wherein according to the selected image objects, determining the attitude information and/or the position information of the movable platform with respect to the positioning auxiliary device includes:
determining each calibration object disposed on the positioning auxiliary device corresponding to each image object in the selected image objects; and
according to position information of each image object in the image and position information of each calibration object corresponding to each image object in the positioning auxiliary device, determining the attitude information and/or the position information of the movable platform with respect to the positioning auxiliary device.

6. The method according to claim 5, wherein determining each calibration object disposed on the positioning auxiliary device corresponding to each image object in the selected image objects includes:
determining position characteristic parameters of each selected image object; and
according to the position characteristic parameters of each selected image object and position characteristic parameters of each calibration object disposed on the positioning auxiliary device, determining each calibration object disposed on the positioning auxiliary device corresponding to each image object in the selected image objects.

7. The method according to claim 6, wherein:
the position characteristic parameters of each calibration object disposed on the positioning auxiliary device are pre-stored in a storage device of the movable platform.

8. The method according to claim 1, wherein selecting the image objects of the calibration objects of the one or more size types from the detected image objects includes:
according to size types of historically matched calibration objects, selecting the image objects of the calibration objects of the one or more size types from the detected image objects, wherein the size types of the historically matched calibration objects are size types of calibration objects selected from a historical image obtained by photographing the positioning auxiliary device and capable of determining the attitude information and/or the position information of the movable platform with respect to the positioning auxiliary device.

9. The method according to claim 1, wherein selecting the image objects of the calibration objects of the one or more size types from the detected image objects includes:
according to a quantity of the image objects of each calibration object of each size type, selecting the image objects of the calibration objects of the one or more size types from the detected image objects.

10. The method according to claim 1, wherein selecting the image objects of the calibration objects of the one or more size types from the detected image objects includes:
according to historical distance information, selecting the image objects of the calibration objects of the one or more size types from the detected image objects, wherein the historical distance information includes distance information of the movable platform with respect to the positioning auxiliary device determined according to a historical image obtained by photographing the positioning auxiliary device.

11. The method according to claim 1, wherein selecting the image objects of the calibration objects of the one or more size types from the detected image objects includes:
determining a selection order of the detected image objects; and
according to the selection order, selecting the image objects of the calibration objects of the one or more size types from the detected image objects.

12. The method according to claim 11, wherein determining the selection order of the detected image objects includes:
according to one or more of: size types of historically matched calibration objects, a quantity of the image objects of each calibration object of each size type, and historical distance information, determining the selection order of the detected image objects,
wherein the size types of the historically matched calibration objects are size types of calibration objects selected from a historical image obtained by photographing the positioning auxiliary device and capable of determining the attitude information and/or the position information of the movable platform with respect to the positioning auxiliary device, and the historical distance information includes distance information of the movable platform with respect to the positioning auxiliary device determined according to the historical image obtained by photographing the positioning auxiliary device.

13. The method according to claim 1, wherein:
the movable platform is an unmanned aerial vehicle.

14. A device for positioning a movable platform, comprising:
a memory, configured to store program instructions; and
a processor, coupled to the memory and when the program instructions being executed, configured to:
obtain an image obtained by photographing a positioning auxiliary device,
wherein the positioning auxiliary device is configured with a plurality of calibration objects of at least two different size types,
detect image objects of each calibration object of each size type in the image, select image objects of the calibration objects of one or more size types from the detected image objects, and
according to the selected image objects, determine attitude information and/or position information of the movable platform with respect to the positioning auxiliary device.

15. The device according to claim 14, wherein when according to the selected image objects, determining the attitude information and/or the position information of the movable platform with respect to the positioning auxiliary device, the processor is configured to:
determine each calibration object disposed on the positioning auxiliary device corresponding to each image object in the selected image objects; and
according to position information of each image object in the image and position information of each calibration object corresponding to each image object in the positioning auxiliary device, determine the attitude information and/or the position information of the movable platform with respect to the positioning auxiliary device.

16. The device according to claim 15, wherein when determining each calibration object disposed on the positioning auxiliary device corresponding to each image object in the selected image objects, the processor is configured to:
determine position characteristic parameters of each selected image object; and
according to the position characteristic parameters of each selected image object and position characteristic parameters of each calibration object disposed on the positioning auxiliary device, determine each calibration object disposed on the positioning auxiliary device corresponding to each image object in the selected image objects.

17. The device according to claim 14, wherein when selecting the image objects of the calibration objects of the one or more size types from the detected image objects, the processor is configured to:
according to size types of historically matched calibration objects, select the image objects of the calibration objects of the one or more size types from the detected image objects, wherein the size types of the historically matched calibration objects are size types of calibration objects selected from a historical image obtained by photographing the positioning auxiliary device and capable of determining the attitude information and/or the position information of the movable platform with respect to the positioning auxiliary device.

18. The device according to claim 14, wherein when selecting the image objects of the calibration objects of the one or more size types from the detected image objects, the processor is configured to:
according to a quantity of the image objects of each calibration object of each size type, select the image objects of the calibration objects of the one or more size types from the detected image objects.

19. The device according to claim 14, wherein when selecting the image objects of the calibration objects of the one or more size types from the detected image objects, the processor is configured to:
according to historical distance information, select the image objects of the calibration objects of the one or more size types from the detected image objects, wherein the historical distance information includes distance information of the movable platform with respect to the positioning auxiliary device determined according to a historical image obtained by photographing the positioning auxiliary device.

20. The device according to claim 14, wherein when selecting the image objects of the calibration objects of the one or more size types from the detected image objects, the processor is configured to:
determine a selection order of the detected image objects; and
according to the selection order, select the image objects of the calibration objects of the one or more size types from the detected image objects.
